(19) United States
(12) Patent Application Publication
(10) Pub. No.: US 2026/0226974 A1
(43) Pub. Date: Aug. 6, 2026

(54) GEARBOX ARCHITECTURE FOR A DUAL ELECTRIC DRIVE UNIT

(71) Applicant: American Axle & Manufacturing, Inc., Detroit, MI (US)

(72) Inventors: Austin R. GERDING, Shelby Township, MI (US); Brendan M. BIJONOWSKI, Detroit, MI (US); Eric Alan RIVETT, Macomb, MI (US); Paul C. ZAWISA, Detroit, MI (US); James Keith MEINTJES, Pontiac, MI (US)

(21) Appl. No.: 19/159,608

(22) PCT Filed: Jan. 22, 2024
(86) PCT No.: PCT/US2024/012336

§ 371 Date: Aug. 25, 2025

Related U.S. Application Data
(60) Provisional application No. 63/448,164, filed on Feb. 24, 2023.

(51) Int. Cl. F16H 57/021; B60K 1/02; H02K 7/00; H02K 7/08; H02K 7/116

(52) U.S. Cl. CPC F16H 57/021; B60K 1/02; H02K 7/003; H02K 7/006; H02K 7/083; H02K 7/116

(57) ABSTRACT

A gearbox architecture for a dual electric drive unit, where each drive unit has an electric motor and a transmission. The gearbox architecture permits compact and cost-effective packaging of the transmissions into a housing to which the electric motors are mounted.

### CROSS-REFERENCE TO RELATED APPLICATIONS

This application claims priority to and is a national phase application of PCT Application PCT/US2024/012336, filed Jan. 22, 2024, which claims the benefit of U.S. Provisional Application No. 63/448,164, filed on Mar. 7, 2023, the disclosures of which are incorporated by reference as if fully set forth in detail herein.

### FIELD

The present disclosure relates to a gearbox architecture for a dual electric drive unit.

### BACKGROUND

With reference to FIG. 1 of the drawings, an exemplary prior art dual electric drive unit is generally indicated by reference numeral 2. The dual electric drive unit 2 include a housing assembly 4 and a pair of electric drive units 6, 8. The housing assembly 4 includes a first housing member 10, a second housing member 12 and an intermediate housing member 14 that is disposed between the first and second housing members 10 and 12. The intermediate housing member 14 cooperates with the first housing member 10 and the second housing member 12 to define one or more cavities (e.g., cavities 16 and 18, respectively) into which portions of the electric drive units 6, 8 can be received. Each of the electric drive units 6,8 includes an electric motor 20 and a transmission 22 having a plurality of gears including a transmission input gear 30, a transmission output gear 32 and optionally one or more pairs of intermediate gears 34. The transmission input gear 30 is mounted on an input shaft 40 and the transmission output gear 32 is mounted on an output shaft 42. If pairs of intermediate gears 34 are employed in the transmission 22, each pair of intermediate gears 34 is mounted on associated intermediate shaft 44

Each of the input shaft 40, the output shaft 42 and the intermediate shaft(s) 44 of the electric drive unit 6 is mounted on a respective pair of shaft bearings 50, with one of the shaft bearings 50 being disposed in the first housing member 10 and a second one of the shaft bearings 50 being disposed in the intermediate housing member 14. Similarly, each of the input shaft 40, the output shaft 42 and the intermediate shaft(s) 44 of the electric drive unit 8 is mounted on a pair of shaft bearings 50, with one of the shaft bearings 50 being disposed in the second housing member 12 and a second one of the shaft bearings 50 being disposed in the intermediate housing member 14. While the three-part configuration of the housing assembly 4 permits the shaft bearings of each of the electric drive units 6, 8 to be installed in an efficient manner, we have discovered that the configuration nevertheless is somewhat inefficient as the intermediate housing member 14 adds mass and volume to the dual electric drive unit 2.

### SUMMARY

This section provides a general summary of the disclosure, and is not a comprehensive disclosure of its full scope or all of its features.

The present disclosure provides a dual electric drive unit with a relatively smaller housing without an intermediate housing member. In one form, the present disclosure provides a dual electric drive unit that includes a housing assembly, a first electric drive unit, a first bearing, a second electric drive unit, a second bearing, a third bearing and a fourth bearing. The housing assembly has a first housing member and a second housing member. The first electric drive unit has a first electric motor, a first transmission and a first output member. The first electric motor is coupled to the first housing member. The first transmission is disposed in the housing assembly and has a first shaft and a first transmission input gear. The first shaft is driven by the first electric motor and defines a first bearing mount, a second bearing mount, and a third bearing mount. The first bearing is mounted to the first housing member and is received on the first bearing mount. The first bearing is configured to support the first shaft for rotation about an input axis relative to the housing assembly. The second electric drive unit has a second electric motor, a second transmission and a second output member. The second electric motor is coupled to the second housing member. The second transmission is disposed in the housing assembly and has a second shaft and a second transmission input gear. The second shaft is driven by the second electric motor and defines a fourth bearing mount, a fifth bearing mount, and a sixth bearing mount. The second bearing is mounted to the second housing member and is received on the sixth bearing mount. The second bearing is configured to support the second shaft for rotation about the input axis relative to the housing assembly. The third bearing is received on the second bearing mount and the fourth bearing mount and supports one of the first and second shafts for rotation relative to the other one of the first and second shafts. The fourth bearing is received on the third bearing mount and the fifth bearing mount and supports the one of the first and second shafts for rotation relative to the other one of the first and second shafts. A portion of the one of the first and second shafts is received coaxially about the other one of the first and second shafts.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a schematic illustration of a dual electric drive unit constructed in accordance with the teachings of the prior art;

FIG. 2 is a schematic illustration of a dual electric drive unit constructed in accordance with the teachings of the present disclosure;

FIG. 3 is a section view of a portion of the dual electric drive unit of FIG. 2;

FIG. 4 is a perspective view of a portion of the dual electric drive unit of FIG. 2 illustrating the transmission input gears of the transmissions of each of the drive units;

FIGS. 5 and 6 are exploded perspective views of the portion of the dual electric drive unit that is depicted in FIG. 3;

FIG. 7 is a section view of a portion of a dual electric drive unit that depicts alternately configured intermediate gears and bearing arrangements suitable for the embodiments of FIGS. 1 and 2; and

FIGS. 8 and 9 are section views similar to that of FIG. 4 but depicting alternative configurations of the input gears for the transmissions.

Corresponding reference numerals indicate corresponding parts throughout the several views of the drawings.

### DETAILED DESCRIPTION

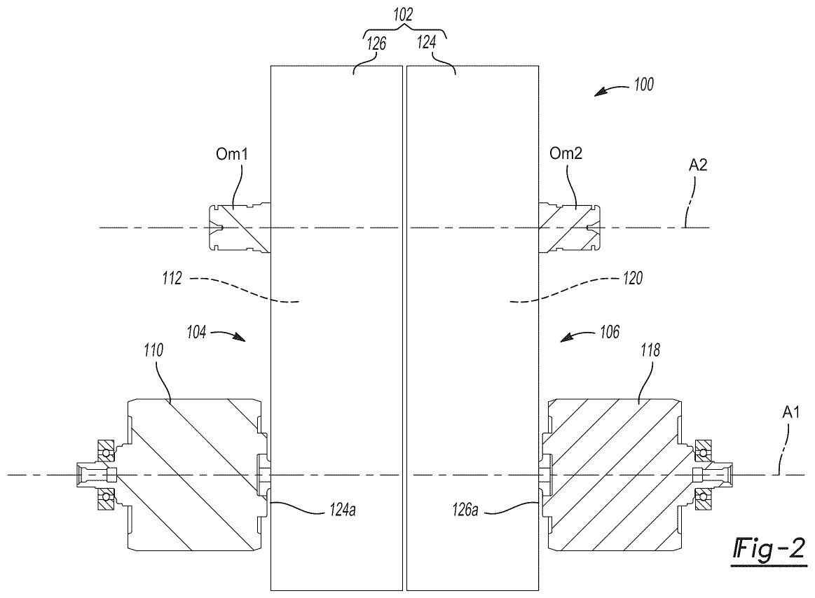

With reference to FIG. 2, an exemplary dual electric drive unit constructed in accordance with the teachings of the present disclosure is generally indicated by reference numeral 100. The dual electric drive unit 100 can include a housing assembly 102, a first drive unit 104 and a second drive unit 106. The first drive unit 104 can have a first motor 110 and a first transmission 112, while the second drive unit 106 can have a second motor 118 and a second transmission 120.

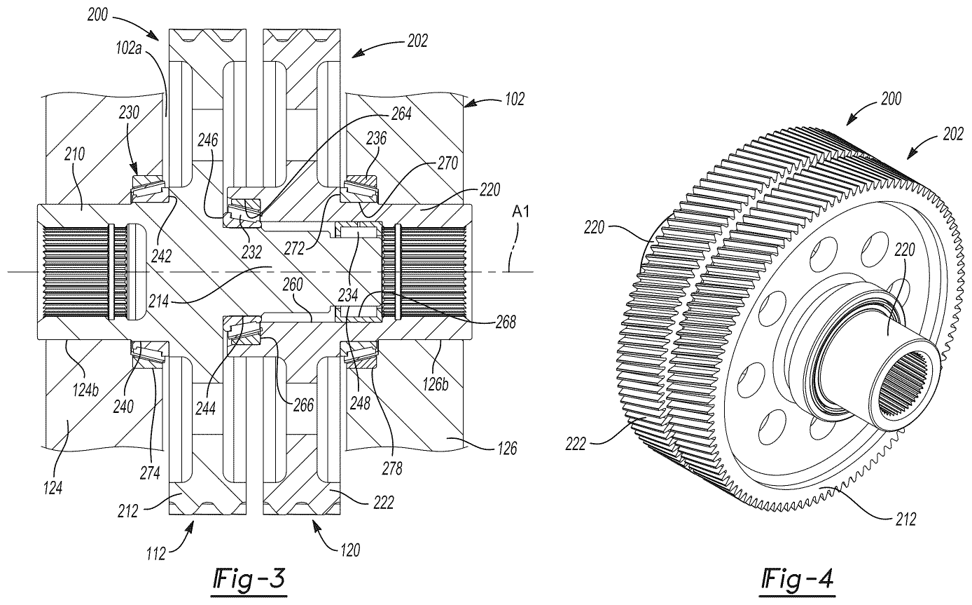

With reference to FIGS. 2 and 3, the housing assembly 102 can have a first housing member 124 and a second housing member 126 that are fixedly coupled to one via a plurality of threaded fasteners (not shown). The first and second housing members 124 and 126 can cooperate to form a drive unit cavity 102a that is configured to house the first and second transmissions 112 and 120. The first housing member 124 defines a first motor mount 124a, and a first input shaft bore 124b, a first input bearing bore 274. The second housing member 126 defines a second motor mount 126b, and a second input shaft bore 278.

The first motor 110 can be fixedly coupled, for example by a plurality of threaded fasteners (not shown) to the first motor mount 124a such that a motor output shaft (not specifically shown) of the first motor 110 extends through the first input shaft bore 124b and into the drive unit cavity 102a. A rotary seal (not specifically shown) can be mounted to the first housing member 124 and can form a seal between the first housing member 124 and the motor output shaft of the first motor 110 or a portion of the first transmission 112 to which the motor output shaft of the first motor 110 is rotatably coupled.

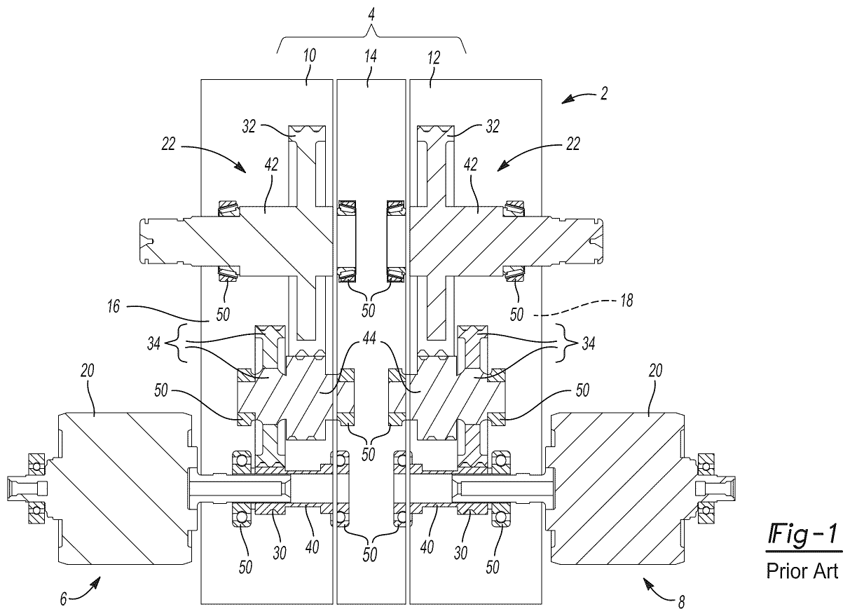

The first transmission 112 can be similar to the transmission 22 (FIG. 1) and can include a first transmission input gear 200, a first transmission output gear (not specifically shown), and optionally one or more pairs of intermediate reduction gears (not specifically shown). The first transmission input gear 200 can be coupled to the motor output shaft of the first motor 110 for rotation therewith about an input axis A1. The first transmission output gear is rotatable about an output axis A2. In situations where the first transmission 112 does not include any pairs of intermediate reduction gears, the first transmission input gear 200 can meshingly engage the first transmission output gear. If included, one or more pairs of intermediate reduction gears can be disposed in a power transmission path between the first transmission input gear 200 and the first transmission output gear. For example, if a single pair of intermediate reduction gears is employed, a first one of the pair of intermediate reduction gears can be meshingly engaged with the first transmission input gear 200, and a second one of the pair of intermediate reduction gears can be meshingly engaged with the first transmission output gear and coupled to the first one of the pair of intermediate reduction gears for rotation therewith about a respective intermediate axis. The first transmission 112 is operable for transmitting rotary power between the first motor 110 and an output member OM1 of the first drive unit 104.

Similarly, the second transmission 120 can be configured similar to the transmission 22 (FIG. 1) and can include a second transmission input gear 202, a second transmission output gear (not specifically shown), and optionally one or more pairs of intermediate reduction gears (not specifically shown). The second transmission input gear 202 can be coupled to the motor output shaft of the second motor 118 for rotation therewith about the input axis A1. The second transmission output gear is rotatable about the output axis A2. In situations where the second transmission 120 does not include any pairs of intermediate reduction gears, the second transmission input gear 202 can meshingly engage the second transmission output gear. If included, one or more pairs of intermediate reduction gears can be disposed in a power transmission path between the second transmission input gear 202 and the second transmission output gear. For example, if a single pair of intermediate reduction gears is employed, a first one of the pair of intermediate reduction gears can be meshingly engaged with the second transmission input gear 202, and a second one of the pair of intermediate reduction gears can be meshingly engaged with the second transmission output gear and coupled to the first one of the pair of intermediate reduction gears for rotation therewith about a respective intermediate axis. The second transmission 120 is operable for transmitting rotary power between the second motor 118 and an output member OM2 of the second drive unit 106.

It will be appreciated that a bearing arrangement can be employed to support the first transmission input gear 200 and the second transmission input gear 202 relative to the housing assembly 102 for rotation about the input axis A1, the first transmission output gear and the second transmission output gear relative to the housing assembly 102 for rotation about the output axis A2, and each pair of intermediate reduction gears, if included, about a respective intermediate axis. It will also be appreciated that each of the bearing arrangements can be generally similar. As such, the bearing arrangements that are described and illustrated below will be shown and described only in conjunction with the first and second transmission input gears, or with a single pair of intermediate reduction gears for each of the first and second transmissions.

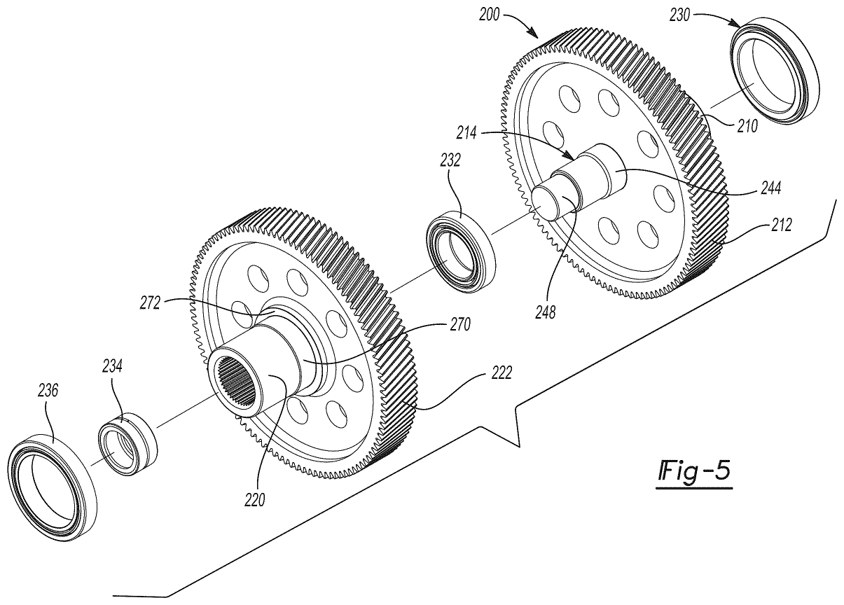

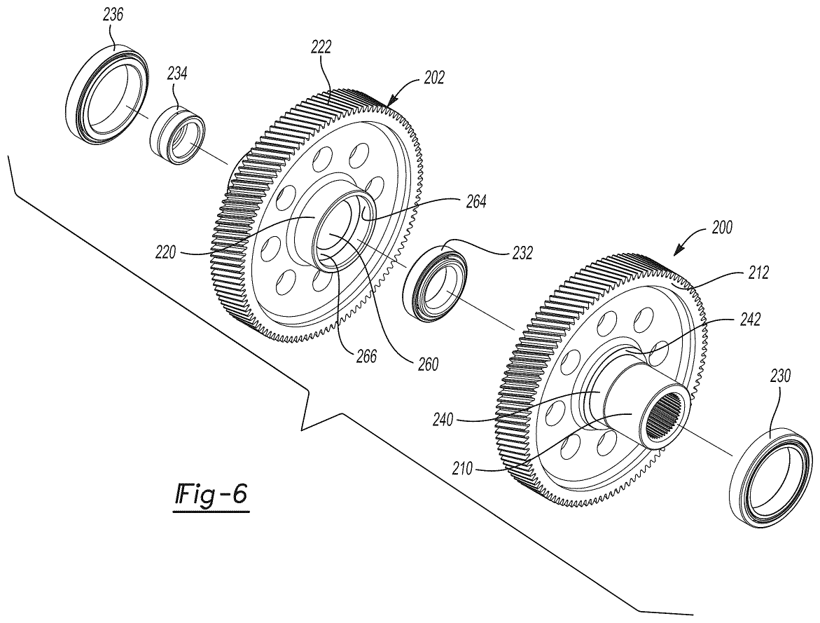

With reference to FIGS. 3 through 6, a first bearing arrangement is illustrated in conjunction with the first and second transmission input gears 200 and 202. In this example, the first transmission input gear 200 includes a first hub 210, a first gear portion 212, and a first shaft portion 214, the second transmission input gear 202 includes a second hub 220, and a second gear portion 222, and the bearing arrangement includes a first tapered roller bearing 230, a second tapered roller bearing 232, a needle bearing 234, and a third tapered roller bearing 236.

The first hub 210 can define an internally-splined aperture that is configured to meshingly engage an externally-splined segment (not shown) on the motor output shaft of the first motor (FIG. 2). The first gear portion 212 can extend radially outward from the first hub 210 and can define a plurality of first gear teeth. A first bearing mount 240 can be formed on the first hub 210 and can terminate at a first shoulder 242. The first shaft portion 214 can be fixedly coupled to the first hub 210 and can extend along the rotational axis of the first transmission input gear 200 in an axial direction away from the first hub 210. A second bearing mount 244 can be formed on the first shaft portion 214 proximate the intersection between the first hub 210 and the first shaft portion 214 and can terminate at a second shoulder 246. A third bearing mount 248 can be formed on the first shaft portion 214 proximate to a distal end of the first shaft portion 214.

The second hub 220 can define an internally-splined aperture, which is configured to meshingly engage an externally-splined segment (not shown) on the motor output shaft of the second motor 118 (FIG. 2), and a shaft aperture 260 that is configured to receive the first shaft portion 214 therein. The second gear portion 222 can extend radially outward from the second hub 220 and can define a plurality of second gear teeth. A fourth bearing mount 264 can be formed on the second hub 220 on a first side of the second gear portion 222 and can terminate at a third shoulder 266. A fifth bearing mount 268 can be formed on the second hub 220. A sixth bearing mount 270 can be formed on the second hub 220 on a second side of the second gear portion 222 that is opposite the first side. The sixth bearing mount can terminate at a fourth shoulder 272.

The first tapered roller bearing 230 can be mounted on the first bearing mount 240 on the first hub 210 of the first transmission input gear 200 and in a seventh bearing mount 274 that is formed in the first housing member 124. The first tapered roller bearing 230 can be abutted against the first shoulder 242. In the example provided, the first tapered roller bearing 230 has an inner bearing race, which is received on the first bearing mount 240 on the first hub 210 and abutted against the first shoulder 242, an outer bearing race, which is received in a bore in the first housing member 124, and a plurality of tapered rollers that are disposed between the inner bearing race and the outer bearing race.

The second tapered roller bearing 232 can be mounted on the second bearing mount 244 and the fourth bearing mount 264. The second tapered roller bearing 232 can be abutted against the second shoulder 246 on the first shaft portion 214 and the third shoulder 266 on the second hub 220. In the example provided, the second tapered roller bearing 232 has an inner bearing race, which is received on the second bearing mount 244 on the first shaft portion 214 and abutted against the second shoulder 246, an outer bearing race, which is received in a bore in the second hub 220 that defines the fourth bearing mount 264, and a plurality of tapered rollers that are disposed between the inner bearing race and the outer bearing race.

The needle bearing 234 can be mounted on the third bearing mount 248 on the distal end of the first shaft portion 214 and the fifth bearing mount 268 on the second hub 220. In the example provided, the fifth bearing mount 268 is formed in the bore in the second hub 220.

The third tapered roller bearing 236 can be mounted on the sixth bearing mount 270 on the second hub 220 of the second transmission input gear 202 and in an eighth bearing mount 278 that is formed in the second housing member 126. The third tapered roller bearing 236 can be abutted against the fourth shoulder 272. In the example provided, the third tapered roller bearing 236 has an inner bearing race, which is received on the sixth bearing mount 270 on the second hub 220 and abutted against the fourth shoulder 272, an outer bearing race, which is received in a bore in the second housing member 126, and a plurality of tapered rollers that are disposed between the inner bearing race and the outer bearing race.

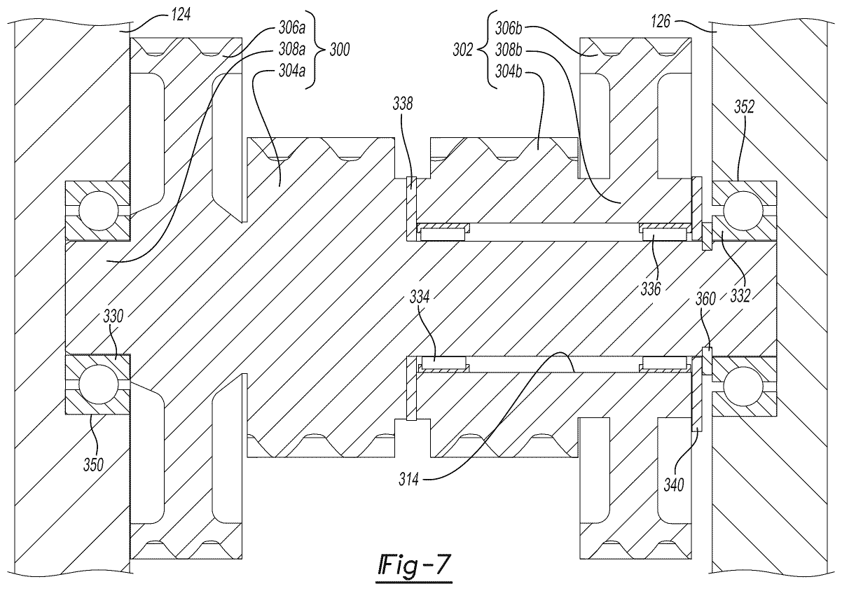

The bearing arrangement that is depicted in FIG. 7 is shown supporting pairs of intermediate gears 300 and 302. The pair of intermediate gears 300 include a first intermediate gear 304a, a second intermediate gear 306a and a shaft portion 308a that extends through the first intermediate gear 304a and the second intermediate gear 306a. The first intermediate gear 304a, the second intermediate gear 306a and the shaft portion 308a are coupled to one another for common rotation about an axis and all or part of the pair of intermediate gears 300 could be unitarily and integrally formed (e.g., the second intermediate gear 306a and the shaft portion 308a could be unitarily and integrally formed and the first intermediate gear 304a could be assembled and fixedly coupled to the shaft portion 308a).

Similarly, the pair of intermediate gears 302 include a first intermediate gear 304b, a second intermediate gear 306b and a shaft portion 308b. The first intermediate gear 304b, the second intermediate gear 306b and the shaft portion 308b are coupled to one another for common rotation about the axis and all or part of the pair of intermediate gears 302 could be unitarily and integrally formed (e.g., the second intermediate gear 306b and the shaft portion 308b could be unitarily and integrally formed and the first intermediate gear 304b could be assembled and fixedly coupled to the shaft portion 308b). The shaft portion 308b defines a shaft bore 314 through which the shaft portion 308a is received.

The bearing arrangement can include a first bearing 330, a second bearing 332, a first needle bearing 334, a second needle bearing 336, a first thrust element 338, and a second thrust element 340.

The first bearing 330 is disposed between the shaft portion 308a on a side of the second intermediate gear 306a that is opposite the first intermediate gear 304a. The first bearing 330 has an inner bearing race, which is mounted directly to the shaft portion 308a, an outer bearing race, which is mounted to a bore 350 in the first housing member 124, and a plurality of rolling elements that are disposed between the inner and outer bearing races. Similarly, the second bearing 332 is disposed between the shaft portion 308b on a side of the second intermediate gear 306b that is opposite the first intermediate gear 306b. The second bearing 332 has an inner bearing race, which is mounted directly to a portion of the shaft portion 308a that extends through the pair of intermediate gears 302, an outer bearing race, which is mounted to a bore 352 in the second housing member 126, and a plurality of rolling elements that are disposed between the inner and outer bearing races.

The first and second needle bearings 334 and 336 are received between the shaft portion 308a and the shaft portion 308b and support the pair of intermediate gears 302 for rotation about the axis relative to the pair of intermediate gears 300.

The first and second thrust elements 338 and 340 can be configured to limit thrust of the pair of intermediate gears 302 relative to the pair of intermediate gears 300. In the example provided, each of the first and second thrust elements 338 and 340 is a thrust washer, the first thrust element 338 is received on the shaft portion 308a between the first intermediate gear 304a and the shaft portion 308b, and the second thrust element 340 is received on the shaft portion 308a between the second intermediate gear 306b and a retaining ring 360 that is mounted to the shaft portion 308a on a side of the second thrust element 340 that is opposite the shaft portion 308b.

It will be appreciated that the first and second bearings 330 and 332 can be any type of bearing. In the example shown, the first and second bearings 330 and 332 are deep groove ball bearings, which are typically smaller and more efficient than tapered roller bearings. If desired, each of the intermediate gears of each pair of intermediate gears can be formed with opposite-handed helical teeth to limit the generation of thrust. For example, the first intermediate gears 304a and 304b can be formed with left-handled helical teeth, while the second intermediate gears 306a and 306b can be formed with right-handed helical teeth.

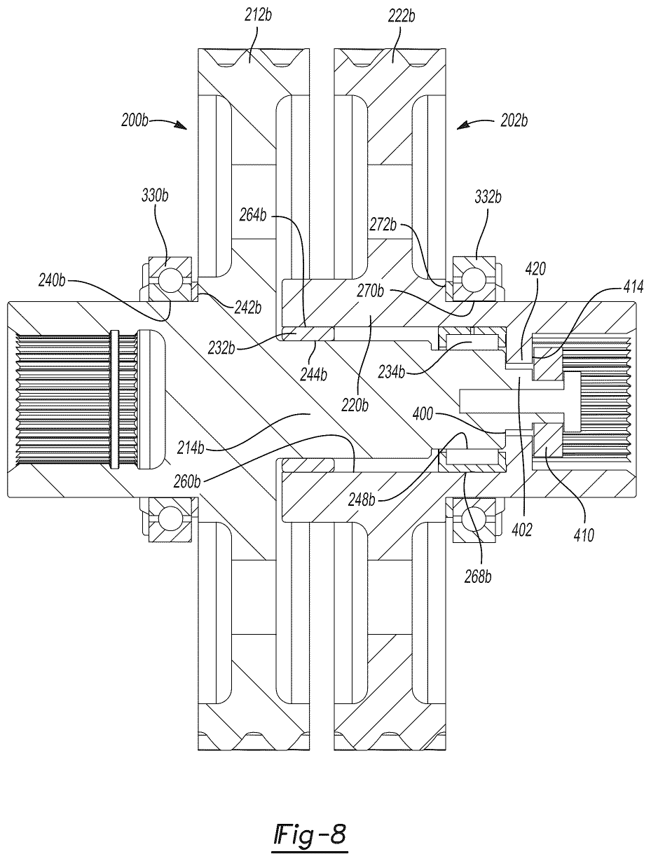

In FIG. 8, a third bearing arrangement is illustrated in conjunction with the first and second transmission input gears 200b and 202b. In this example, the first transmission input gear 200b includes a first hub 210b, a first gear portion 212b, and a first shaft portion 214b, the second transmission input gear 202b includes a second hub 220b, and a second gear portion 222b, and the bearing arrangement includes a first bearing 330b, a second bearing 232b, a third bearing 234b and a fourth bearing 332b.

The first hub 210b can define an internally-splined aperture that is configured to meshingly engage an externally-splined segment (not shown) on the motor output shaft of the first motor (FIG. 2). The first gear portion 212b can extend radially outward from the first hub 210b and can define a plurality of first gear teeth. A first bearing mount 240b can be formed on the first hub 210b and can terminate at a first shoulder 242b. The first shaft portion 214b can be fixedly coupled to the first hub 210b and can extend along the rotational axis of the first transmission input gear 200b in an axial direction away from the first hub 210b. A second bearing mount 244b can be formed on the first shaft portion 214b proximate the intersection between the first hub 210b and the first shaft portion 214b. A third bearing mount 248b can be formed on the first shaft portion 214b proximate to a distal end of the first shaft portion 214b.

The second hub 220b can define an internally-splined aperture, which is configured to meshingly engage an externally-splined segment (not shown) on the motor output shaft of the second motor 118 (FIG. 2), and a shaft aperture 260b that is configured to receive the first shaft portion 214b therein. The second gear portion 222b can extend radially outward from the second hub 220b and can define a plurality of second gear teeth. A fourth bearing mount 264b can be formed on the second hub 220b on a first side of the second gear portion 222b. A fifth bearing mount 268b can be formed on the second hub 220b. A sixth bearing mount 270b can be formed on the second hub 220b on a second side of the second gear portion 222b that is opposite the first side. The sixth bearing mount can terminate at a second shoulder 272b.

The first bearing 330b can be mounted on the first bearing mount 240b on the first hub 210b of the first transmission input gear 200b and in a seventh bearing mount (not shown) that is formed in the first housing member (not shown). The first bearing 330b can be abutted against the first shoulder 242b. In the example provided, the first bearing 330b has an inner bearing race, which is received on the first bearing mount 240b on the first hub 210b and abutted against the first shoulder 242b, an outer bearing race, which is received in a bore in the first housing member 124b, and a plurality of rolling elements that are disposed between the inner bearing race and the outer bearing race.

The second bearing 232b can be mounted on the second bearing mount 244b and the fourth bearing mount 264b. In the example provided, the second bearing 332 is a needle bearing having an inner bearing race, which is received on the second bearing mount 244 on the first shaft portion 214 and abutted against the second shoulder 246, an outer bearing race, which is received in a bore in the second hub 220 that defines the fourth bearing mount 264, and a plurality of rollers that are disposed between the inner bearing race and the outer bearing race.

The third bearing 234b can be mounted on the third bearing mount 248b on the distal end of the first shaft portion 214b and the fifth bearing mount 268b on the second hub 220b. In the example provided, the third bearing 234b is a needle bearing and the fifth bearing mount 268b is formed in the bore in the second hub 220b.

The fourth bearing 332b can be mounted on the sixth bearing mount 270b on the second hub 220b of the second transmission input gear 202b and in an eighth bearing mount (not shown) that is formed in the second housing member (not shown). The fourth bearing 332b can be abutted against the second shoulder 246b. In the example provided, the fourth bearing 332b has an inner bearing race, which is received on the sixth bearing mount 270b on the second hub 220b and abutted against the second shoulder 246b, an outer bearing race, which is received in a bore in the second housing member (not shown), and a plurality of rolling elements that are disposed between the inner bearing race and the outer bearing race.

Thrust surfaces can be coupled to the first shaft portion 214b and the second hub 220b to control axial thrust between the first and second transmission input gears 200b and 202b. In the example provided, the first shaft portion 214b defines a first thrust face 400 and a stem 402 that projects axially away from the first thrust face 400. The stem 402 has a first stem portion, which has a first diameter, and a second stem portion that has a second, smaller diameter so that a stem shoulder is formed where the second stem portion intersects the first stem portion. A thrust washer 410 is mounted to the second stem portion and is fixedly coupled to the stem 402 via a threaded fastener. The thrust washer 410 forms a second thrust face 414. A gap or space is disposed along the stem between the first and second thrust faces 400 and 414. An annular projection 420 is coupled to the second hub 220b and extends radially into the space between the first and second thrust faces 400 and 414. The annular projection 420 forms a first complementary thrust face, which is configured to cooperate with the first thrust face 400 to limit thrust that would tend to drive the first transmission input gear 200b toward the second transmission input gear 202b, and a second complementary thrust face, which is configured to cooperate with the second thrust face to limit thrust that would tend to drive the first transmission input gear 200b away from the second transmission input gear 202b.

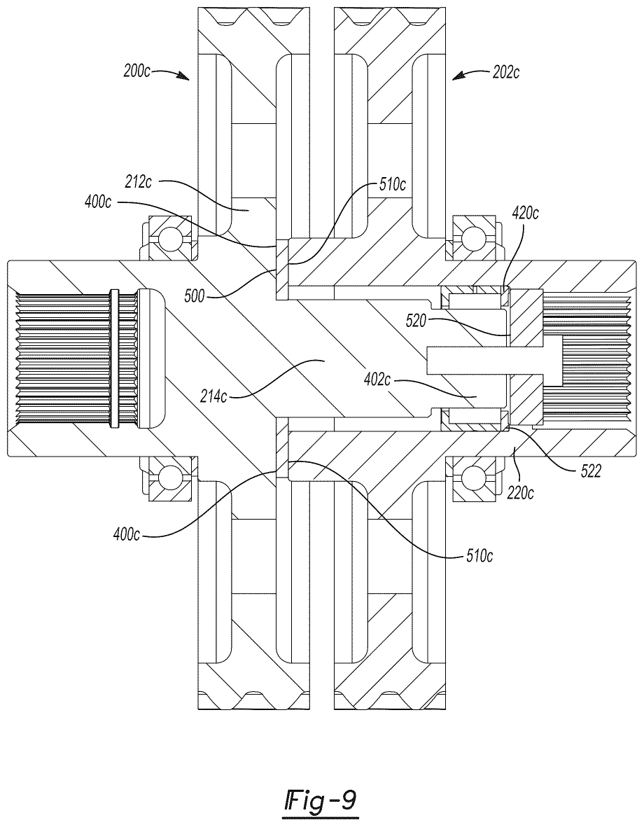

The example of FIG. 9 is similar to that of FIG. 8 except for the inclusion of a second thrust washer 500, which is employed to limit thrust that would tend to drive the first transmission input gear 200c toward the second transmission input gear 202c, and the simplification of the stem 402c so that the annular projection 420c and the first thrust washer 410c to limit thrust that would tend to drive the first transmission input gear 200c away from the second transmission input gear 202c. The second thrust washer 500 is received over the first shaft portion 214c and is disposed against a first thrust face 400c, which is formed on the first gear portion 212c where the first shaft portion 214c intersects the first gear portion 212c, and a first complementary thrust face 510 that is formed on an axial end of the second hub 220c. The first thrust washer 410c is mounted to the axial end of the stem 402c and defines a second thrust face 520 that is engagable to a second complementary thrust face 522 that is formed on the annular projection 420c.

It will be appreciated that tapered roller bearings could be substituted for the deep groove ball bearings that are depicted in the examples of FIGS. 8 and 9.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1. A dual electric drive unit comprising:
a housing assembly having a first housing member and a second housing member;
a first electric drive unit having a first electric motor, a first transmission and a first output member, the first electric motor being coupled to the first housing member, the first transmission being disposed in the housing assembly and having a first shaft and a first transmission input gear, the first shaft being driven by the first electric motor and defining a first bearing mount, a second bearing mount, and a third bearing mount;
a first bearing mounted to the first housing member and received on the first bearing mount and configured to support the first shaft for rotation about an input axis relative to the housing assembly;
a second electric drive unit having a second electric motor, a second transmission and a second output member, the second electric motor being coupled to the second housing member, the second transmission being disposed in the housing assembly and having a second shaft and a second transmission input gear the second shaft being driven by the second electric motor and defining a fourth bearing mount, a fifth bearing mount, and a sixth bearing mount;
a second bearing mounted to the second housing member and received on the sixth bearing mount and configured to support the second shaft for rotation about the input axis relative to the housing assembly;
a third bearing received on the second bearing mount and the fourth bearing mount and supporting one of the first and second shafts for rotation relative to the other one of the first and second shafts; and
a fourth bearing received on the third bearing mount and the fifth bearing mount and supporting the one of the first and second shafts for rotation relative to the other one of the first and second shafts;
wherein a portion of the one of the first and second shafts received coaxially about the other one of the first and second shafts.

2. The dual electric drive unit of claim 1, wherein at least one of the third bearing and the fourth bearing is a roller bearing.

3. The dual electric drive unit of claim 2, wherein the third bearing is a needle bearing.

4. The dual electric drive unit of claim 2, wherein the fourth bearing is a needle bearing.

5. The dual electric drive unit of claim 1, further comprising a thrust washer disposed between the first shaft and the second shaft.

6. The dual electric drive unit of claim 1, wherein each of the first shaft and the second shaft has an internally splined aperture that is configured to accommodate a motor output shaft of a respective one of the first and second electric motors.

7. The dual electric drive unit of claim 1, wherein the first transmission further includes a first shaft portion and first and second intermediate gears that are coupled to the first shaft portion for common rotation, wherein the second transmission further includes a second shaft portion and third and fourth intermediate gears that are coupled to the second shaft portion for common rotation, and wherein one of the first and second shaft portions is received coaxially within the other one of the first and second shaft portions.

8. The dual electric drive unit of claim 7, wherein a pair of needle bearings is received between the first and second shaft portions.

9. The dual electric drive unit of claim 7, further comprising a first thrust washer disposed between the first and third intermediate gears along a rotational axis of the first and second shaft portions.
